(19) United States
(12) Patent Application Publication
(10) Pub. No.: US 2010/0064661 A1
(43) Pub. Date: Mar. 18, 2010

(54) INJECTOR HEAD OF LIQUID ROCKET ENGINE

(75) Inventors: Seong Hyeon Seo, Daejeon (KR); Hwan Seok Choi, Daejeon (KR)

Correspondence Address: RABIN & Berdo, PC, 1101 14TH STREET, NW, SUITE 500, WASHINGTON, DC, 20005, US

(73) Assignee: KOREA AEROSPACE RESEARCH INSTITUTE, Daejeon (KR)

(21) Appl. No.: 12/363,146

(22) Filed: Jan. 30, 2009

(30) Foreign Application Priority Data
Sep. 16, 2008 (KR) 10-2008-0090779

(51) Int. Cl. F02K 9/00

(52) U.S. Cl. 60/258

(57) ABSTRACT

An injector head of a liquid rocket engine in which a mixture of oxidizer and fuel is supplied to a combustion chamber, including an injection plate having through-holes, a partition plate mounted above the injection plate so as to define a space between itself and the injection plate, a fuel injector which injects the fuel supplied from a fuel manifold into the combustion chamber, with an upper portion thereof engaged with a lower surface of the partition plate and a lower portion thereof inserted into the through-holes of the injection plate, and an oxidizer injector engaged with an upper surface of the partition plate so as to inject the oxidizer supplied from an oxidizer manifold, wherein the partition plate is provided with an oxidizer supply hole through which the oxidizer injected from the oxidizer injector is delivered towards the fuel injected from the fuel injector.

### BACKGROUND OF THE INVENTION

1. Field of the Invention

The present invention relates, in general, to an injector head of a liquid rocket engine, and more precisely to an injector head of a liquid rocket engine using bipropellants of oxidizer and fuel.

2. Description of the Related Art

Generally, rockets are an apparatus which obtains thrust by injecting high pressure gas generated upon burning propellants, in order to launch a satellite into orbit. Since a rocket engine burns the propellants quickly so as to provide a large quantity of power, the rocket engine consumes a great amount of propellants in a short time, generating high temperature combustion gas.

A liquid rocket engine is a device in which oxidizer stored therein is mixed with fuel and combusted in a combustion chamber, and exhaust gas generated therefrom is discharged out via a nozzle, resulting in providing thrust using a principle of action and reaction. Liquid rockets are more preferred than solid rockets because of easy control of a rate of combustion via a valve and a pump, and also easy re-ignition.

In operation of such a liquid rocket engine, the propellants, i.e. the oxidizer and fuel, is injected through an injector of an engine head. The fuel includes gasoline, paraffin, liquid hydrogen, or the like, and the oxidizer includes dinitrogen tetraoxide, liquid oxygen, or the like.

Meanwhile, since the oxidizer supplies oxygen which is required for combustion of fuel, rockets can travel in space having little or no oxygen.

As illustrated in FIG. 1, an injector head of a liquid rocket engine of the related art includes an injection plate 11 defining an upper surface of a combustion chamber and through which a mixture of oxidizer and fuel is supplied to the combustion chamber and having a plurality of holes, a partition plate 12 having holes corresponding to those of the injection plate 11 and vertically separated from the injection plate 11 so as to form space between itself and the injection plate 11, and an injector 13 inserted into the holes of the injection plate 11 and the partition plate 12 and through which the fuel is supplied from a fuel manifold FM provided between the injection plate 11 and the partition plate 12, and the oxidizer is supplied from an oxidizer manifold OM provided above the partition plate 12, so as to inject the fuel and oxidizer into the combustion chamber.

The injection plate 13 includes, on one side, oxidizer holes 13a through which the oxidizer is supplied from the oxidizer manifold OM, and on the other side, fuel holes 13b through which the fuel is supplied from the fuel manifold FM.

Since the partition plate 12 divides space into two sub-spaces for installing the oxidizer manifold OM and the fuel manifold FM, the partition plate prevents the oxidizer and the fuel from being mixed in the injector head, rather than in the combustion chamber.

However, the conventional injector head of the liquid rocket engine has a problem in that it is fabricated in a single unit and is welded onto the partition plate 12 and the injection plate 11, so that the oxidizer or the fuel may leak at a welded surface N. That is, if the oxidizer and the fuel are mixed not in the combustion chamber, but in the injection head, combustion or explosion may occur in the injection head, thereby breaking the injector head.

Particularly, since the liquid rocket engine includes many injectors 13, there are many welded surfaces N. Further, if the liquid rocket engine is subjected to excessive heat and pressure through repeated combustion, unlike an initial state, fatigue accumulates in the injector head, so that sealability at the welded surfaces N cannot be maintained.

Further, when the injector head of the liquid rocket engine is fabricated, it is necessary to check whether the welded surfaces N formed on the partition plate 12 are maintained in a sealed state. To this end, additional manufacturing and measuring tools are required for determining whether the welded surfaces N are maintained in the sealed state, which makes it troublesome and costly to fabricate the injector head.

Moreover, the injector head of the liquid rocket engine is fabricated into a single piece while assembling sub-parts, which have been machined, before conducting a quality test for checking hydraulic characteristics of oxidizer and fuel. Herein, even if only one of fuel and oxidizer does not satisfy a reference condition in the quality test, the entire injector is problematically considered to be defective.

### SUMMARY OF THE INVENTION

Accordingly, the present invention has been made keeping in mind the above problems occurring in the related art, and the present invention is intended to propose an injector head of a liquid rocket engine in which oxidizer and fuel are respectively supplied to a combustion chamber via separate injectors, so that there is no welded surface on a partition plate dividing a space into sub-spaces for oxidizer and fuel, thereby preventing leakage of fuel or oxidizer.

In order to achieve the above object, according to one aspect of the present invention, there is provided an injector head of a liquid rocket engine in which a mixture of oxidizer and fuel is supplied to a combustion chamber, the injector head including: an injection plate forming an upper surface of the combustion chamber and having a plurality of through-holes; a partition plate mounted above the injection plate so as to define a space between itself and the injection plate; a fuel injector which injects the fuel, which is supplied from a fuel manifold provided between the injection plate and the partition plate, into the combustion chamber, with an upper portion thereof engaged with a lower surface of the partition plate and a lower portion thereof inserted into the through-holes of the injection plate; and an oxidizer injector engaged with an upper surface of the partition plate so as to inject the oxidizer which is supplied from an oxidizer manifold provided on the partition plate, wherein the partition plate is provided with an oxidizer supply hole through which the oxidizer injected from the oxidizer injector is delivered towards the fuel injected from the fuel injector.

In an embodiment, the oxidizer injector is provided with an oxidizer injection hole, which corresponds to an inlet of the oxidizer supply hole of the partition plate, and an inflow hole, via which the oxidizer flows, at its lower surface and side surface, respectively; the fuel injector is of a hollow pipe in shape and is provided, on the side surface, with an inflow hole via which the fuel flows from the fuel manifold; the partition plate is provided with a protrusion protruding into the hollow pipe of the fuel injector; and the oxidizer supply hole is provided on the protrusion of the partition plate.

The oxidizer injector is provided, on its lower end, with a first flange coming into contact with the upper surface of the partition plate, on which a first bead is provided so as to cover the first flange of the oxidizer injector.

The oxidizer supply hole of the partition plate has a female thread at its inlet, and the oxidizer injector is provided, on its lower portion, with a male thread to be engaged with the female thread of the oxidizer supply hole.

The fuel injector is provided, on its upper end, with a second flange coming into contact with the lower surface of the partition plate on which is provided a second bead so as to cover the second flange of the fuel injector, and the fuel injector is provided, on its lower end, with a third bead covering the circumference of the through-hole of the injection plate.

The oxidizer injector is brazed onto the partition plate, and the fuel injector is brazed onto the partition plate and the injection plate.

According to the present invention, the injector head of the liquid rocket engine has the advantage in that the oxidizer injector for supplying the oxidizer to the combustion chamber and the fuel injector for supplying the fuel to the combustion chamber are separately provided so as to prevent the oxidizer or the fuel from leaking and being mixed in the injector head.

Further, since the oxidizer injector and the fuel injector are separately fabricated, even if one or the other becomes defective, only the defective injector needs to be replaced without substituting all the injectors, thereby advantageously reducing the maintenance costs.

Furthermore, since the oxidizer injector and the fuel injector are separately fabricated, respectively conducted with a flow test, and then assembled together, the injector can advantageously be of an optimal mixture ratio.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a cross-sectional view illustrating an injector head of a liquid rocket engine according to the prior art;

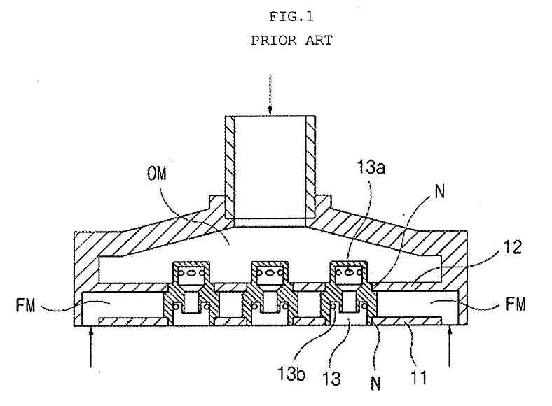

FIG. 2 is a cross-sectional view illustrating an injector head of a liquid rocket engine according to the present invention;

FIG. 3 is an exploded view illustrating the state in which the injector head of the liquid rocket engine is not yet assembled according to an embodiment of the invention;

FIG. 4 is a cross-sectional view illustrating the state in which the injector head of the liquid rocket engine has been assembled;

FIG. 5 is an exploded view illustrating the state in which the injector head of the liquid rocket engine is not yet assembled according to another embodiment of the invention;

FIG. 6 is a cross-sectional view illustrating a flow test device for an oxidizer injector in the injector head of the liquid rocket engine according to the present invention; and

FIG. 7 is a cross-sectional view illustrating a flow test device for a fuel injector in the injector head of the liquid rocket engine according to the present invention.

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts. Prior to describing the present invention, terms or words used in the description and claims should be construed not as general or dictionary meanings, but as meanings and concepts conforming to the technical scopes of the present invention on the basis of the principle that the inventor(s) can properly define the concepts of terms in order to explain his invention in the best way.

Thus, since the exemplary embodiments described in this specification and drawings merely pertain to preferred ones of the invention so they do not completely include all the technical scopes of the present invention, it should be understood that the present invention may include other changes and modifications which can substitute the embodiments at the time when the present invention is filed.

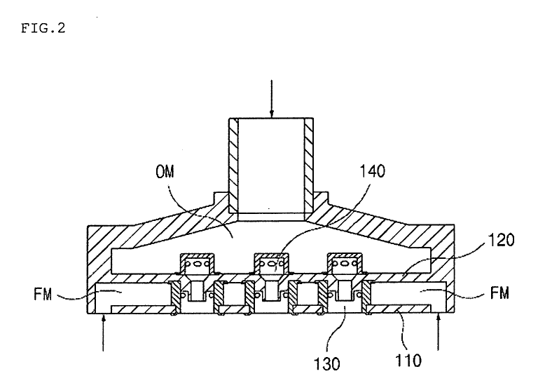

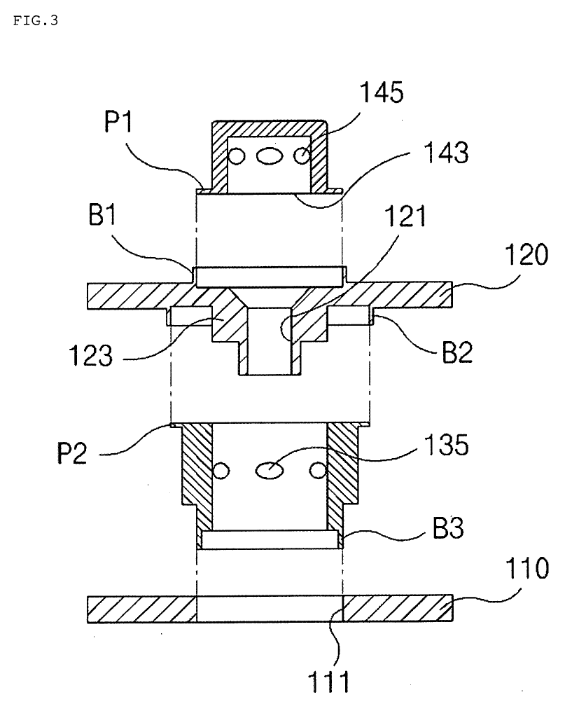

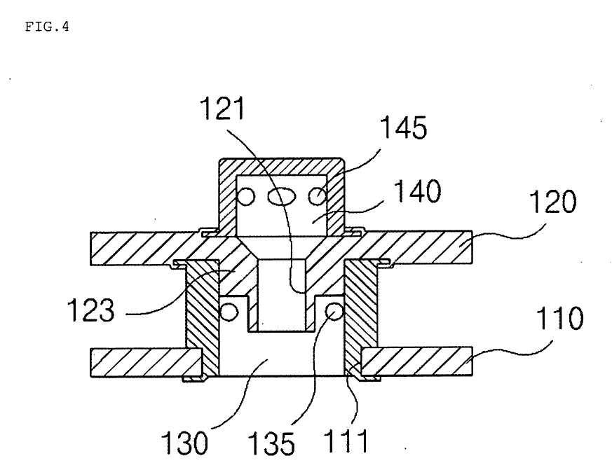

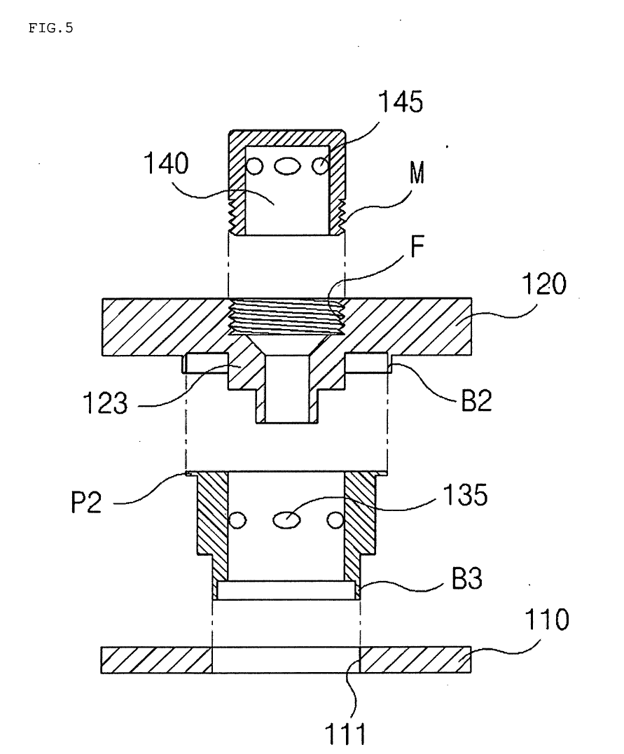

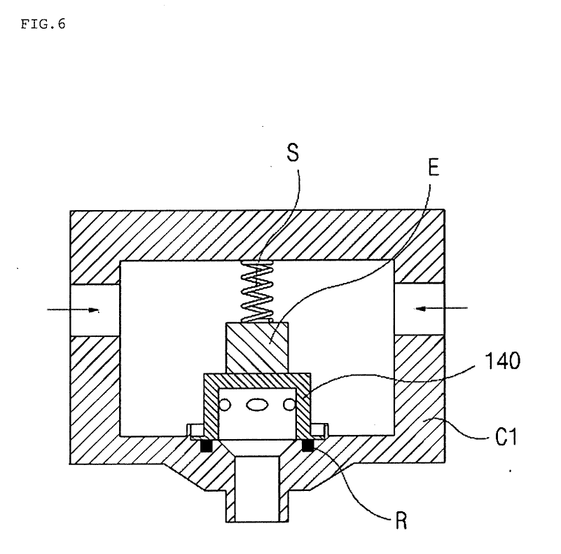

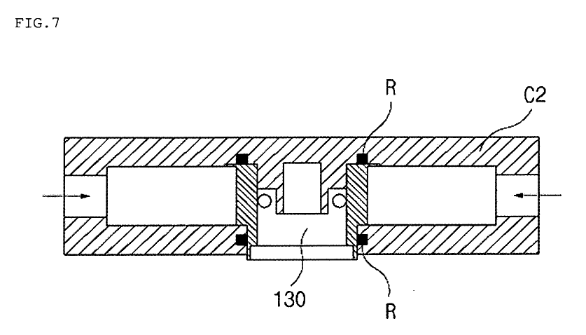

FIG. 2 is a cross-sectional view illustrating an injector head of a liquid rocket engine according to the present invention, FIG. 3 is an exploded view illustrating the state in which the injector head of the liquid rocket engine is not yet assembled according to an embodiment of the invention, FIG. 4 is a cross-sectional view illustrating the state in which the injector head of the liquid rocket engine has been assembled, FIG. 5 is an exploded view illustrating the state in which the injector head of the liquid rocket engine is not yet assembled according to another embodiment of the invention, FIG. 6 is a cross-sectional view illustrating a flow test device for an oxidizer injector in the injector head of the liquid rocket engine according to the present invention, and FIG. 7 is a cross-sectional view illustrating a flow test device for a fuel injector in the injector head of the liquid rocket engine according to the present invention.

Provided is the injector head of the liquid rocket engine in which a mixture of oxidizer and fuel is supplied to the combustion chamber. The injector head includes an injection plate 110 forming an upper surface of the combustion chamber and having a plurality of through-holes 111, a partition plate 120 mounted above from the injection plate 110 so as to define a space between itself and the injection plate 110, a fuel injector 130 which injects the fuel, which is supplied from a fuel manifold FM provided between the injection plate 110 and the partition plate 120, into the combustion chamber, with an upper portion thereof engaged with a lower surface of the partition plate 120 and a lower portion thereof inserted into the through-holes 111 of the injection plate 110, and an oxidizer injector 140 engaged with an upper surface of the partition plate 120 so as to inject the oxidizer which is supplied from an oxidizer manifold OM provided on the partition plate 120. The partition plate 120 is provided with an oxidizer supply hole 121 through which the oxidizer injected from the oxidizer injector 140 is delivered towards the fuel injected from the fuel injector 130.

The oxidizer manifold OM communicates with an oxidizer tank (not shown) so as to supply it to the oxidizer injector 140. Further, the fuel manifold FM communicates with a fuel tank (not shown) so as to supply it to the fuel injector 130.

The injection plate 110 defines the upper surface of the combustion chamber and divides a space into the fuel manifold FM and the combustion chamber.

The oxidizer supply hole 121 of the partition plate 120 is provided in a position corresponding to an installation position of the oxidizer injector 140 and the fuel injector 130 such that the oxidizer injected from the oxidizer injector 140 is mixed with the fuel injected from the fuel injector 130.

The oxidizer injector 140 is provided with an oxidizer injection hole 143, which corresponds to an inlet of the oxidizer supply hole 121 of the partition plate 120, and an inflow hole 145, via which the oxidizer flows in, at its lower surface and side surface, respectively. That is, the inflow hole 145 communicates with the oxidizer manifold OM, and the oxidizer injection hole 143 communicates with the oxidizer supply hole 121 of the partition plate 120.

The fuel injector 130 is of a hollow pipe in shape and is provided, on the side surface, with an inflow hole 135, via which the fuel flows in from the fuel manifold FM. Particularly, the fuel injector 130 may be formed with a cylindrical hollow pipe, a circumferential face of which is provided with the inflow holes 135 communicating with the fuel manifold FM.

The partition plate 120 is provided with a protrusion 123 protruding into the hollow pipe of the fuel injector 130, and the oxidizer supply hole 121 is provided on the protrusion 123 of the partition plate 120. That is, the fuel injector 130 is engaged with the partition plate 120 and the injection plate 110 at its upper and lower portions, respectively such that the protrusion 123 of the partition plate 120 is positioned inside the fuel injector 130.

The oxidizer injector 140 is provided, on its lower end, with a first flange P1 coming into contact with the upper surface of the partition plate 120, on which a first bead B1 is provided so as to cover the first flange P1 of the oxidizer injector 140. Particularly, in order to catch the oxidizer injector 140 onto the partition plate 120, the partition plate 120 is provided with the first bead B1 so as to cover the upper surface of the first flange P1 of the oxidizer injector 140.

Alternatively, as shown in FIG. 5, the oxidizer supply hole 121 of the partition plate 120 has a female thread F at its inlet, and the oxidizer injector 140 is provided, on its lower portion, with a male thread M to be engaged with the female thread F of the oxidizer supply hole 121.

Further, the fuel injector 130 is provided, on its upper end, with a second flange P2 coming into contact with the lower surface of the partition plate 120, on the lower surface of which is provided a second bead B2 so as to cover the second flange P2 of the fuel injector 130. That is, in order to catch the upper portion of the fuel injector 130 onto the partition plate 120, the partition plate 120 is provided, on its lower surface, with the second bead B2 so as to cover the lower surface of the second flange P2 of the fuel injector 130.

Further, the fuel injector 130 is provided, on its lower end, with a third bead B3 covering the circumference of the through-hole 111 of the injection plate 110. That is, in order to catch the lower portion of the fuel injector 130 onto the injection plate 110, the partition plate 120 is provided, on its lower end, with the third bead B3 so as to cover the circumference of an outlet of the through-hole 111 of the injection plate 110.

The oxidizer injector 140 is brazed onto the partition plate 120, and the fuel injector 130 is brazed onto the partition plate 120 and the injection plate 110.

The operation and effects of the injector head of the liquid rocket engine having the above construction will be described as follows.

The oxidizer injector 140 and the fuel injector 130 are respectively coupled, as separate parts, onto the upper and lower surfaces of the partition plate 120 in the injector head of the liquid rocket engine.

The oxidizer injector 140, as shown in FIG. 3, is arranged onto the partition plate 120 such that the oxidizer injection hole 143 corresponds to the inlet of the oxidizer supply hole 121. Herein, the first flange P1 of the oxidizer injection hole 143 comes into contact with the upper surface of the partition plate 120, and the first bead B1 of the partition plate 120 is bent towards the first flange P1 of the oxidizer injector 140 so as to catch the oxidizer injector 140.

Alternatively, as shown in FIG. 5, the oxidizer injector 140 may be screwed into the partition plate 120.

The fuel injector 130 is arranged such that it is aligned with the oxidizer supply hole 121 of the partition plate 120 and the through-hole 111 of the injection plate 110. Herein, the second flange P2 of the fuel injector 130 comes into contact with the lower surface of the partition plate 120, and the second bead B2 of the partition plate 120 is bent towards the second flange P2 of the fuel injector 130 so as to catch the upper portion of the fuel injector 130.

Further, the lower portion of the fuel injector 130 is inserted into the through-hole 111 of the injection plate 110, and the third bead B3 of the fuel injector 130, which is inserted into the through-hole 111 of the injection plate 110, is bent towards the circumference of the through-hole 111 of the injection plate 110 so as to catch the lower portion of the fuel injector 130.

The fuel injector 130 caught as such then is brazed onto the injection plate 110 and the partition plate 120. In addition, the oxidizer injector 140 caught as such is brazed onto the partition plate 120.

The oxidizer supplied from the oxidizer manifold OM to the inflow hole 145 of the oxidizer injector 140 is injected into the oxidizer supply hole 121 of the partition plate 120 via the oxidizer injection hole 143 of the oxidizer injector 140.

The oxidizer injected into the oxidizer supply hole 121 of the partition plate 120 then is mixed with the fuel injected from the fuel injector 130. That is, onto the upper and lower surfaces of the partition plate 120, the oxidizer injector 140 and the fuel injector 130 are respectively coupled.

Thus, since a welded surface between the fuel injector 130 and the partition plate 120 is not formed on the upper surface of the partition plate 120, the fuel is advantageously prevented from leaking towards the upper portion of the partition plate 120 and being mixed with the oxidizer.

Meanwhile, the performances of the oxidizer injector 140 and the fuel injector 130 constructed as such can be tested by separate testers. That is, as shown in FIG. 6, the oxidizer injector 140 is assembled into a flow test device C1 in such a way that an O-ring R is mounted on a contact surface therebetween so as to maintain sealability. Further, a rubber plate E and a spring S are provided between the upper surface of the oxidizer injector 140 and the inner surface of the flow test device C1 so as to press the oxidizer injector 140 against the inside of the flow test device, thereby holding the oxidizer injector in the flow test device with a proper pressure.

Further, as shown in FIG. 7, the fuel injector 130 is assembled into a flow test device C2 such that an O-ring R is disposed therebetween so as to maintain sealability.

The oxidizer injector 140 and the fuel injector 130 can be respectively subjected to a flow test through the introduction of fluid via inlets of the flow test devices so as to check which injector is defective. Thus, only the defective injector can be removed, thereby having the effect of reducing the maintenance costs.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An injector head of a liquid rocket engine in which a mixture of oxidizer and fuel is supplied to a combustion chamber, the injector head including:
an injection plate forming an upper surface of the combustion chamber and having a plurality of through-holes;
a partition plate mounted above the injection plate so as to define a space between itself and the injection plate;
a fuel injector which injects the fuel, which is supplied from a fuel manifold provided between the injection plate and the partition plate, into the combustion chamber, with an upper portion thereof engaged with a lower surface of the partition plate and a lower portion thereof inserted into the through-holes of the injection plate; and
an oxidizer injector engaged with an upper surface of the partition plate so as to inject the oxidizer which is supplied from an oxidizer manifold provided on the partition plate,
wherein the partition plate is provided with an oxidizer supply hole through which the oxidizer injected from the oxidizer injector is delivered towards the fuel injected from the fuel injector.

2. The injector head of a liquid rocket engine according to claim 1, wherein the oxidizer injector is provided with an oxidizer injection hole, which corresponds to an inlet of the oxidizer supply hole of the partition plate, and an inflow hole, via which the oxidizer flows, at its lower surface and side surface, respectively,
wherein the fuel injector is of a hollow pipe in shape and is provided, on the side surface, with an inflow hole via which the fuel flows from the fuel manifold, and
wherein the partition plate is provided with a protrusion protruding into the hollow pipe of the fuel injector, the oxidizer supply hole being provided on the protrusion of the partition plate.

3. The injector head of a liquid rocket engine according to claim 1, wherein the oxidizer injector is provided, on its lower end, with a first flange coming into contact with the upper surface of the partition plate, on which a first bead is provided so as to cover the first flange of the oxidizer injector.

4. The injector head of a liquid rocket engine according to claim 2, wherein the oxidizer injector is provided, on its lower end, with a first flange coming into contact with the upper surface of the partition plate, on which a first bead is provided so as to cover the first flange of the oxidizer injector.

5. The injector head of a liquid rocket engine according to claim 1, wherein the oxidizer supply hole of the partition plate has a female thread at its inlet, and the oxidizer injector is provided, on its lower portion, with a male thread to be engaged with the female thread of the oxidizer supply hole.

6. The injector head of a liquid rocket engine according to claim 2, wherein the oxidizer supply hole of the partition plate has a female thread at its inlet, and the oxidizer injector is provided, on its lower portion, with a male thread to be engaged with the female thread of the oxidizer supply hole.

7. The injector head of a liquid rocket engine according to claim 3, wherein the fuel injector is provided, on its upper end, with a second flange coming into contact with the lower surface of the partition plate, on which is provided a second bead so as to cover the second flange of the fuel injector, and the fuel injector is provided, on its lower end, with a third bead covering the circumference of the through-hole of the injection plate.

8. The injector head of a liquid rocket engine according to claim 4, wherein the fuel injector is provided, on its upper end, with a second flange coming into contact with the lower surface of the partition plate, on which is provided a second bead so as to cover the second flange of the fuel injector, and the fuel injector is provided, on its lower end, with a third bead covering the circumference of the through-hole of the injection plate.

9. The injector head of a liquid rocket engine according to claim 5, wherein the fuel injector is provided, on its upper end, with a second flange coming into contact with the lower surface of the partition plate, on which is provided a second bead so as to cover the second flange of the fuel injector, and the fuel injector is provided, on its lower end, with a third bead covering the circumference of the through-hole of the injection plate.

10. The injector head of a liquid rocket engine according to claim 6, wherein the fuel injector is provided, on its upper end, with a second flange coming into contact with the lower surface of the partition plate, on which is provided a second bead so as to cover the second flange of the fuel injector, and the fuel injector is provided, on its lower end, with a third bead covering the circumference of the through-hole of the injection plate.

11. The injector head of a liquid rocket engine according to claim 1, wherein the oxidizer injector is brazed onto the partition plate, and the fuel injector is brazed onto the partition plate and the injection plate.
